(19) United States
(12) Patent Application Publication
(10) Pub. No.: US 2012/0023594 A1
(43) Pub. Date: Jan. 26, 2012

(54) METHOD AND APPARATUS FOR MANAGING CONSUMPTION RIGHT FOR MULTIMEDIA SERVICE

(75) Inventors: Sung-Oh HWANG, Yongin-si (KR); Sergey Nikolayevich SELEZNEV, Suwon-si (KR); Jae-Yeon SONG, Seoul (KR); Byung-Rae LEE, Seoul (KR)

(73) Assignee: Samsung Electronics Co., Ltd., Suwon-si (KR)

(21) Appl. No.: 13/187,128

(22) Filed: Jul. 20, 2011

(30) Foreign Application Priority Data
Jul. 20, 2010 (KR) 10-2010-0070048

(51) Int. Cl. G06F 7/04; H04N 7/16

(52) U.S. Cl. 726/28

(57) ABSTRACT

Disclosed is a method and an apparatus for managing a consumption right for each stage for a service including a plurality of stages or episodes. The right issuer includes the access condition, which allows an access to the Right Object (RO) for each stage, in the right object representing the consumption right for the stepped multimedia service and then transfers the right object to the device. When the stepped multimedia service is executed, the device obtains the access information satisfying the access condition corresponding to a corresponding stage from the right issuer or a service provider and then transfers the access information to the RO, allowing a user to access the RO and execute a service of the corresponding stage by using the RO.

### PRIORITY

This application claims priority under 35 U.S.C. §119(a) to a Korean Patent Application entitled “Method and Apparatus for Managing Consumption Right for Multimedia Service” filed in the Korean Industrial Property Office on Jul. 20, 2010 and assigned Serial No. 10-2010-0070048, the contents of which are incorporated herein by reference.

### BACKGROUND OF THE INVENTION

1. Field of the Invention

The present invention relates generally to a user's consumption right for a multimedia service, and more particularly, to a method and an apparatus for managing a consumption right for each stage for a service including a plurality of stages or episodes.

2. Description of the Related Art

In order to receive multimedia services such as broadcasting or on-demand content transmission, a device generally accesses a server providing the content. Service providers provide the multimedia service content and charge a fee in proportion to the time for which the device accesses the server providing the service or the amount of data provided to the device. The service providers manage the consumption right for the service in order to protect the multimedia service or the content, or charge a fair fee.

A DRM (Digital Rights Management), which is a technique for protecting the multimedia service, protects the service or the content from illegal circulation and distribution. The DRM has been developed in order to guarantee the safe distribution of, and prevent the illegal distribution of, the paid service or content. The DRM collectively supports the generation, circulation, and management of the service or the content, such as safely protecting rights and interests of the service provider or the content provider, preventing illegal distribution, charging a fee, and providing a vicarious execution of settlement.

The multimedia services include stepped services including a plurality of episodes or stages such as a game or a soap opera having a series of episodes. The DRM is also used in order to protect the stepped services.

The DRM technique is shown in FIG. 1. FIG. 1 illustrates a process for providing a conventional RO (Right Object). The RO represents a consumption right of a user for a corresponding service. In FIG. 1, a device 10 is a user device for being provided with a multimedia service to be executed, and a right issuer 20 is a server for issuing the RO representing the consumption rights corresponding to various types of multimedia services. An authentication server (or Online Certificate Status Protocol (OCSP) server) 30 is responsible for the authentication when the device 10 uses the multimedia service.

As the user of the device 10 controls the stepped multimedia service, such as to execute a game service, the device 10 makes a request for the RO of the game service selected by the user to the right issuer 20 by using an RO request message in step 101.

Accordingly, the right issuer 20 inquires to the authentication server 30 about whether the device 10 requesting the RO has a right for making the request for the RO in step 103 (which corresponds to an OCSP request). The authentication server 30 has public key or certificate information, and has an authentication protocol for executing the authentication of the device 10. After performing authentication work based on the public key or certificate information provided by the device 10, the authentication server 30 transfers a result of the authentication work to the right issuer 20 by using an OCSP response message in step 105.

When the OSCP response message is affirmative, that is, the authentication for the device 10 is appropriately completed, the right issuer 20 having received the OCSP response message generates a suitable RO and transfers the generated RO to the device by using the RO response message in step 107.

In step 109, the device 10 informs the right issuer 20 that the RO received in step 107 is normally installed, by using an RO confirmation request message. The right issuer 20 informs the device 10 that the right issuer 20 normally receives the RO confirmation request message through an RO confirmation response message in step 111.

The RO generated by the right issuer 20 in step 107 can be configured either by giving the RO encryption keys and rights, which can execute all stages of the game service, or by giving the RO an individual encryption and rights, which can execute each stage of the game service.

Referring to FIG. 1, in the first method, the RO is transmitted only once to minimize the transmission of the RO in using the game service. However, the user may pay for the unnecessary cost because encryption keys for all stages are transmitted. For example, although the user may no longer be interested in executing the game after a first stage, the RO which can execute all stages has been already received and the cost has been already paid.

In the second method, the RO can be received for each stage, which the user desires, so that the cost can be minimized. However, there exists a disadvantage in that all processes shown in FIG. 1 should be repeated whenever each stage is executed. That is, the RO should be transmitted every time, which wastes resources of the device 10, the right issuer 20, and the authentication server 30.

It is necessary to use the DRM, which is the content protection technique, in order to protect the multimedia service including a plurality of stages or series, but there is required a plan that minimizes user inconvenience and a DRM system management overhead when the user uses the service based on the DRM.

It is possible to protect the stepped multimedia service by using the current DRM technique, but the user inconveniently cannot help spending much time before obtaining the RO, which the user requires, because the RO, which is the consumption right, is generated for each stage and the content is transmitted together with the RO every stage. Further, an overhead according to the transmission of the RO can be generated. In another scheme, one RO corresponding to one service can be generated, but in this case, the protection or the charge of the individual content for each stage cannot be efficiently implemented.

Therefore, a method is needed for minimizing user inconvenience and the RO management overhead of the DRM.

### SUMMARY OF THE INVENTION

Accordingly, the present invention has been made to solve the above-stated problems occurring in the prior art, and the present invention provides a method and an apparatus for managing a consumption right, which can protect a stepped multimedia service.

The present invention also provides a method and an apparatus in which the user can conveniently obtain the consumption right for the stepped multimedia service.

The present invention further provides a method and an apparatus, which can effectively manage the consumption right for the stepped multimedia service and provide the consumption right with a minimum overhead.

In accordance with an aspect of the present invention, there is provided a method for managing a user's consumption right for a multimedia service by a device, including receiving an execution request for a specific multimedia service from a user, requesting for access information corresponding to the access condition to a service network when an access condition for the user's consumption right corresponding to the specific multimedia service is set to the consumption right, receiving the access information from the service network, and providing the user with content for the specific multimedia service by a range defined by the consumption right when the access information meets the access condition.

In accordance with another aspect of the present invention, there is provided an apparatus for managing a user's consumption right for a multimedia service in a device, including an agent for requesting for access information corresponding to an access condition to a multimedia player when the access condition for the user's consumption right corresponding to a specific multimedia service is set to the right consumption, and providing the multimedia player with content for the specific multimedia service by a range defined by the consumption right when the access information transferred from the multimedia player meets the access condition, as a result of receiving a request for a specific content corresponding to an execution of the specific multimedia service from the multimedia player, and the multimedia player for transmitting a request for the specific content to the agent, requesting for or transmitting the access information to a service network according to the request for the access information of the agent, transferring the access information to the agent, and executing the content transferred from the agent when receiving an execution request for the specific multimedia service from the user.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates a conventional process of providing a consumption right;

FIG. 2 illustrates a construction of a DRM system according to the present invention;

FIG. 3 illustrates a process of managing the consumption right according to the present invention.

### DETAILED DESCRIPTION OF EMBODIMENTS OF THE INVENTION

Hereinafter, embodiments of the present invention will be described in detail with reference to the accompanying drawings. In the following description, the same elements will be designated by the same reference numerals although they are shown in different drawings. Further, a detailed description of known functions and configurations incorporated herein will be omitted for the sake of clarity and conciseness.

For convenience of the description of the present invention, names of technique and objects defined in a DRM of an OMA (Open Mobile Alliance), which is a mobile broadcast application standard organization, will be identically used. However, the standard and the names do not limit the scope of the present invention and can be applied to a consumption right management system having a similar technical background.

Multimedia services such as a broadcasting service or an on-demand content transmission service include a stepped multimedia service providing individual content stage by stage, such as a game played in stages or a soap opera series including a plurality of episodes. In the stepped multimedia service, it is preferable that a user obtain a consumption right for each individual content, since there are a plurality of individual contents for one service, in aspects of the content protection and the charging.

For example, a game includes a plurality of stages and can be configured in such a manner that a user enters a next stage after completing one stage. Because the user obtains the consumption right for each stage, the fee can be appropriated for each stage. In the soap opera series including a plurality of episodes, the user can also obtain the consumption right for each episode to watch a next episode.

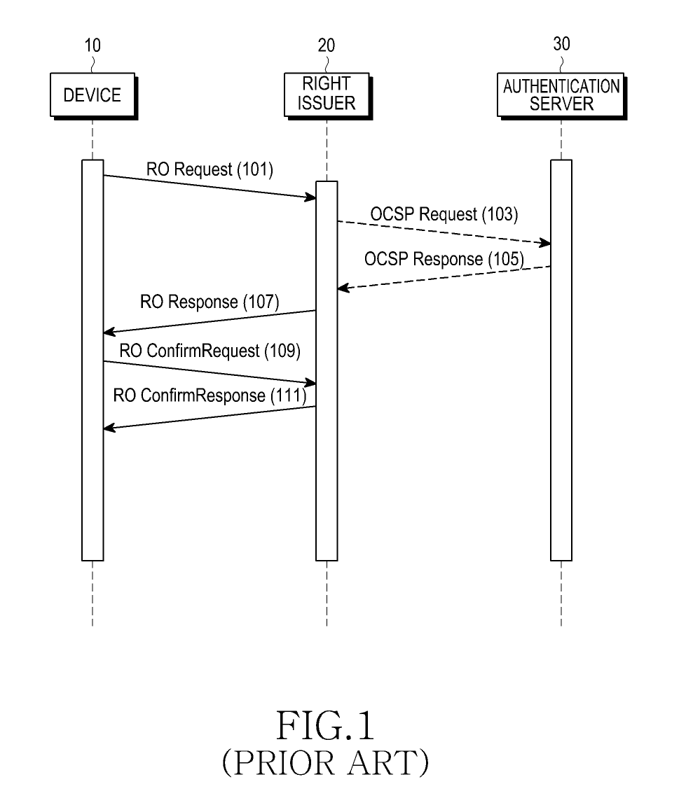

Accordingly, in a conventional DRM system, an RO is transferred to a device through a series of processes for the generation and transmission of the RO including information for the user's consumption right at every stage, that is, the process shown in FIG. 1, or all ROs are transferred to the device when a first service is provided. Therefore, the problem occurs in which the user is unnecessarily charged or additional resources are unnecessarily consumed.

The present invention has been made to solve the above problems and according to the present invention, the right issuer includes an access condition to the RO for each stage in the RO representing the consumption right for the stepped multimedia service and then transfers the RO to the device. When the device executes the stepped multimedia service, the device obtains access information, which can meet the access condition corresponding to a corresponding stage, from the right issuer or a service provider and then transfers the access information to the RO so that the device can access the RO and execute the service of the corresponding stage.

The access condition to the RO may include a specific access code. That is, one or more access codes corresponding to each stage are included in the RO as the access condition. The device obtains the access code corresponding to the specific stage in order to use a multimedia service corresponding to the specific stage and then transfers the access code to the RO. When the device transfers a suitable access code to the RO, the device can use the consumption right for the multimedia service.

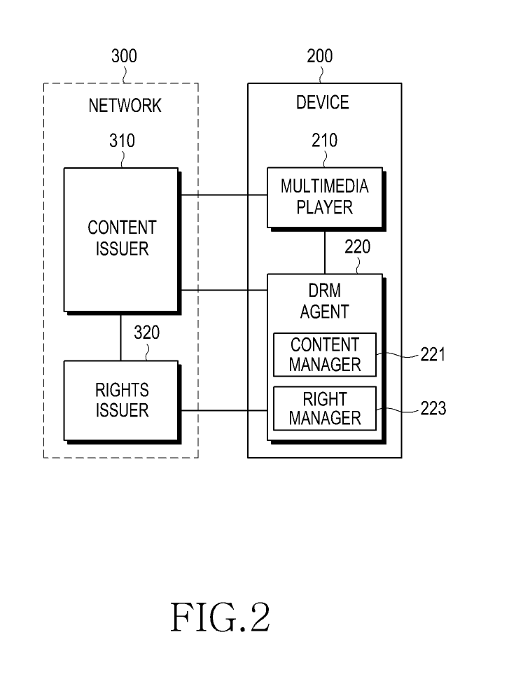

FIG. 2 illustrates the DRM system according to an embodiment of the present invention. Referring to FIG. 2, a service network 300 includes a content issuer 310 and the right issuer 320, and the device 200 includes a multimedia player 210 and a DRM agent 220. A network 100 is an area of an operator and a content provider providing the multimedia service or the content, and the device 100 is a area of a user consuming the multimedia service or the content.

The network 300 includes the content provider (not shown) providing a content or a service. The content provider provides the content issuer 310 with various types of contents to be provided through the multimedia service. The content issuer 310 is an apparatus for making content provided from the content provider into a suitable form. The content issuer 310 approves the content in a system to which the DRM system is applied, processes a request for providing a content sent by a user, and transfers the RO to the device 200 of the user, wherein the RO represents an encryption key required to reproduce a content encrypted according to an agreement with the right issuer 320 and a reproduction and consumption right of the content.

The right issuer 320 is an apparatus for registering and authenticating the user device 200, which will use the DRM, and generating and transferring the RO for a content required from the user device 200. The right issuer 320 also monitors whether the content is consumed according to a right set to the RO and receives a report for a current state of the content consumption from the device 200.

The right issuer 320 includes a transmission/reception unit (not shown), which can transmit and receive data from/to the device 200 and a manager (not shown) for managing the RO as discussed in the following description.

The device 200 includes the multimedia player 200 and the DRM agent 220, and can be formed of hardware, software, or a combination thereof. The device 200 can consume the content provided from the network 300 by using the DRM technique.

The media player 210 is an entity, which can reproduce the content and an advertisement. The media player 210 receives decrypted content from the DRM agent 220 to reproduce the content. Further, the media player 210 receives a key, which can decrypt encrypted content, from the DRM agent 220 to decrypt the content, and then reproduces the content.

The DRM agent 220 includes a content processing engine (or content manager) 221 and a right manager 223. The content processing engine 221 decrypts the encrypted content according to a request for providing the content, provides the decrypted content to the media player 210, and brings a key to be used in a decryption process from the right manager 223 for the decryption operation.

The right manager 223 registers the device 200 to the right issuer 320, obtains the RO for the content to be consumed by the device 110, and manages the consumption of the RO.

Entities on both the network 300 and the device 200 in FIG. 2 may include different entities from each other or complex entities.

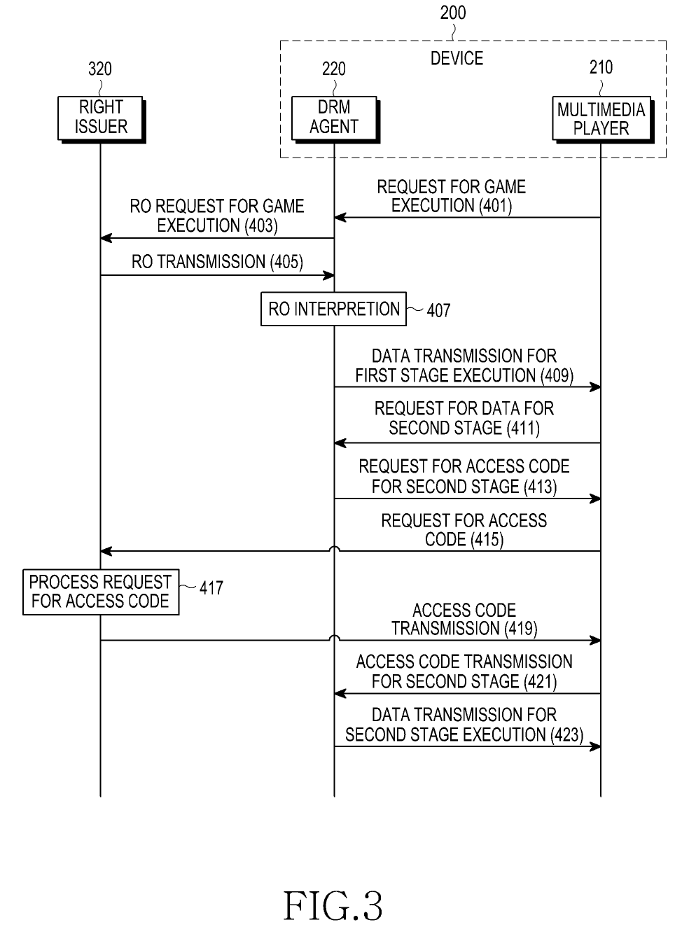

FIG. 3 illustrates a consumption right management process according to an embodiment of the present invention. In FIG. 3, for convenience of the description, it is assumed that the stepped multimedia service is a game service, but the present invention can be applied to the multimedia service such as a soap opera service including a plurality of episodes having a similar structure.

Referring to FIG. 3, when there is a request for executing a specific game service from a user, the multimedia player 210 of the device 200 executes an application, which can execute the game service. The multimedia player 210 transmits a request for game execution message to the DRM agent 220 in response to the request of the user in step 401, to make a request for decrypting encrypted game data to the DRM agent 200 so as to execute the specific game service. All the encrypted game data, or only an execution file or metadata required for executing the game, can be in an encrypted state.

The DRM agent 220 determines in step 401 whether there is the RO for the game service requested from the multimedia player 210. When there is no corresponding RO, the DRM agent 220 transmits an RO request for game execution message to the right issuer 320 in step 403 to request the RO, which enables the corresponding game service to be executed, to the right issuer 210. The RO can already exist in the DRM agent 220, but it is assumed in FIG. 3 that the RO is requested after the DRM agent 220 receives the request for game execution message in step 401.

The right issuer 320 generates the RO indicating the consumption right for the corresponding game service in step 405 after a proper authentication process to transmit the RO to the DRM agent 220 of the device 200. The generated RO includes information indicating the consumption right for the corresponding multimedia service and an access condition to the RO. In the present invention, an access code is used as the access condition. That is, the RO includes an access code value for each stage corresponding to a part of content data to be used in each stage among all contents of the corresponding multimedia service. Accordingly, in order to use the RO, the device 200 should obtain the corresponding access code as access information to the RO. The information included in the RO can be defined as shown in Tables 1-4.

Table 1 is an example of a new permission element generated by including the access condition disclosed in the present invention in a permission element used in an REL (Right Expression Language) used to generate the RO in the OMA DRM.

TABLE 1
Element <permission>

| | |
|---|---|
| element | <!ELEMENT o-ex:permission(o-ex:constraint?, o-ex:asset*, o-dd:play?, o-dd:display?, |
| | o-dd:execute?, o-dd:print?, oma-dd:export?, o-dd:access?)> |
| semantics | The<permission> element contains an optional onExpiredURL attribute, an optional |
| | <constraint> element, zero or more <asset>elements and a set of optional permissions |
| | specifying the rights over a piece of Content, such as <play>, <display>, <execute>, |
| | <print>, <export> and <access> permission elements. |
| | The <constraint> element is the top-level constraint. As a sibling element to other |
| | permission elements such as <play>, <display> it applies to all sibling permission |
| | elements inside the same <permission> element. The DRM Agent MUST honour the |
| | top level constraint in addition to honouring possible constraints specified as a child |
| | element to permission element, e.g., <play>, when granting access to content |
| | according to such a permission. |
| | Note that the DRM Agent MUST respect both, constraints specified as child elements to |
| | a permission element and those specified as top-level constraints in the same Rights |
| | Object. I.e., the stricter of two constraints of the same type prevails for a given |
| | permission element. Of course, Rights Objects with contradictory constraints should not |
| | be issued in the first place. |
| | When there is a top-level constraint that is otherwise not allowed as a child constraint to |
| | a permission, e.g., <count> and <export mode=” move” >, the child constraint takes |
| | precedence over the top-level constraint as applied to this permission. For example, in |
| | the move scenario, Content and Rights Object would be moved, and the <cont> |
| | constraint would accordingly be removed, too. |
| | The <asset> elements specified within the <permission> element enable expression |
| | linking allowing its sibling permission elements (e.g. <play>, <display>) in the same |
| | contained in an <agreement> element (I.e., outside a <permission> element). The link |
| | is established through the use of the “ id” and “ idref” attributes. |
| | A DRM Agent UMST grant access to DRM Content referenced by an <asset> element |
| | in the agreement model according to permissions specified inside a <permission> |
| | element that is as sibling elements to an <asset> element in the permission model, |
| | where the <asset> element referencing the DRM Content and the <asset> element |
| | inside the <permission> element are linked by matching “ id” and “ idref” attributes. |
| | If no <asset>element is present in a <permission>element, then the permission applies |
| | to all <asset> sibling elements in the same Rights Object. |
| | The <export> permission is associated with all <asset> elements within the same Right |
| | Object. This implies that there SHOULD only be one <export> element within the Right |
| | Object. Therefore the <permission> element containing an <export> element MUST |
| | NOT contain an <asset> element. |

The permission element sets a right range of the RO including the permission element, which includes basic restrictions on the permission element, a content identifier for which the permission element is used, or components indicating whether the content is executed or displayed, can be performed or printed, or the RO can be transferred to other devices. The permission element includes an access element, which is a new element according to the present invention. The access element indicates that there is an access condition for accessing a related RO, and a structure of a disclosed access element is as shown in Table 2.

TABLE 2
Element <access>

| | |
|---|---|
| element | <!ELEMENT o-dd:access(o-ex:constraint?, o-ex:requirement(+)> |
| semantics | The <access> element grants permissions over the DRM Content associated to the |
| | individual features of applications(e.g. game component). |
| | If the<requirement> element is specified, the DRM Agent MUST ensure that the |
| | requirements specified by this element are fulfilled before using the permission |
| | element. |
| | The <access> element MUST contain <access-code> requirement. |
| | IF the <constraint> element is specified the DRM Agent MUST grant the access rights |
| | according to the <constraint> child element and/or the top-level <constraint> element |
| | if any. For example, <datetime> element contained in a <constraint> child element of |
| | <access> is used to specify time range when the application feature is accessible. |
| | The <access> element has the semantics of allowing application access to the |
| | selected DRM Contents followed by the decryption of that content by DRM Agent or |
| | provisioning associated decryption key to the application. |

In Table 2, the access element includes a constraint element and a requirement element. The constraint element includes many restraints with regard to the access element, and an example of the restraints may include an expiration date of the access element. The requirement element indicates a condition required for using the RO. When the requirement element is not satisfied, the permission element can not be executed.

The requirement element in Table 2 is as shown in Table 3.

TABLE 3
Element <requirement>

| | |
|---|---|
| element | <!ELEMENT o-ex:requirement (o-dd:tracked?, o-dd:access-code?)> |
| semantics | The <requirement> element contains an optional <tracked> element. |
| | Requirements are associated with one permission element at a time. For a permission |
| | to be granted all its requirements MUST be fulfilled. If a requirement is not understood |
| | or cannot be enforced by the consuming Device the associated permission is invalid |
| | and MUST NOT be granted. |
| | If present, a <requirement> element SHOULD contain the <tracked> element. If a |
| | <requirement> element does not contain the <tracked> element, it does not require |
| | any specific pre-condition to be fulfilled. |
| | The <requirement> element MUST only be present as a child element to other |
| | permission elements such as <play> and <display>, it MUST NOT be present as a |
| | top-level requirement. If a DRM Agent receives an RO with a top-level requirement it |
| | MUST ignore this requirement. |

Referring to Table 3, the requirement element includes an access code element which is a value that should be input to the user or the DRM agent 220 in order to access the RO. When a proper value is not input to the user or the DRM agent 220, an access to the RO connected to the permission element is not allowed. The access code element includes a key information element, and an access code is encrypted and stored in a key designated by the key information element. The access code element is as shown in Table 4.

TABLE 4
Element <access code>

| | |
|---|---|
| element | <!ELEMENT o-ex:access-code(ds:KeyInfo*)> |
| semantics | The <access-code> element indicates that the parent |
| | permission can be granted only when access code(key) |
| | conveyed in the <KeyInfo> element is supplied by the |
| | requestor of DRM content. |
| | <KeyInfo>element is defined in [DRM-REL] for carrying |
| | encrypted data. Access code MUST be encrypted with REK. |

When the RO including the above element is transferred to the device 200, the user should obtain an access code identical to the access code stored in the access code element included in the RO to make the obtained access code transferred to the DRM agent 220, in order to execute a multimedia service content.

Schemes for transferring the access code to the user or the device 200 can be various. For example, a short message or a multimedia message used in mobile communication, or an HTTP (Hypertext Transport Protocol) can be used to transfer the access code.

When the access code obtained or input by the user is not identical to the value stored in the access code element, a corresponding RO cannot be used and consequently, a corresponding multimedia service is not performed. There are various methods for using the access code, such as in an execution of the multimedia service content in the first stage or in a specific stage for convenience of the user.

In FIG. 3, as described above, the generated RO is transferred to the DRM agent 310 of the device 200 in step 405. A message used at this time can be an RO response message. The DRM agent 220 interprets the received RO in step 407 and then transfers game data for executing the game of a first stage to the multimedia player 210. The game data corresponding to the first stage can be a decrypted game, an execution file for executing the game, or metadata to be used in the game of the first stage, as described above. A consumption right for the game data corresponding to the first stage can be accessed without the access code, or the required access code may be included in the RO transferred in step 405.

A user having completed a game play of the first stage can make a request for a second stage execution to the multimedia player 210. Accordingly, the multimedia player 210 performs the movement to obtain data for the game of the second stage. That is, the multimedia player 210 operates with two different methods according to contents included in data transferred in step 409.

When contents including a requirement for the access code for executing the second stage in step 409 are transferred to the multimedia player 210, the multimedia player 210 can directly transmit an access code request message to the right issuer 320. If only data for executing a content is transmitted in step 409, the multimedia player 210 will make a request for data for executing the second stage to the DRM agent 220. In FIG. 3, the second case is described as an example.

Accordingly, the multimedia player 210 makes a request for the data for executing the second stage to the DRM in step 411. The DRM agent 220 makes a request for transmitting the access code to the multimedia player 210 in step 413.

The need for the access code can be informed to the user through a pop-up or a separate message, and the user can obtain a suitable access code through a direct movement. Alternatively, the multimedia player 210 can automatically make a request for the access code to the right issuer 320 by using a setting of the multimedia player 210. A location (address) of the right issuer 320 can be informed to the multimedia player 210 by the DRM agent 220, or can be input to the multimedia player 210 through a separate method. An example of the separate method may be inputting the address of the right issuer 320 in an installation of the multimedia player 210.

The multimedia player 210 in FIG. 3 makes a request for the access code to the right issuer 320 according to a request of the DRM agent 220. The right issuer 320 having received the request requires user information of the multimedia player 210 or the device 200 in order to process the request for the access code in step 417. When the required information is not provided, there is no basis on which the right issuer 320 can determine the suitability of the multimedia player 210 or the user. After an authentication of the multimedia player 210 or an authentication for the user is completed, the right issuer 320 transfers the access code to the device 200 in step 419. As described above, various methods can be used for transferring the access code.

In FIG. 3, the right issuer 320 is described as a subject issuing the access code, but the content issuer 310 can also issue the access code. When issuing the access code, the content issuer 310 issues a value or makes a request for transmitting the access code designated by the content issuer 310 to the right issuer 120.

The multimedia player 210 having received the transmission of the access code in step 419 transmits the access code for executing the multimedia service of the second stage to the DRM agent 220 in step 421.

The DRM agent 220 compares the value stored in the access code element of Table 4 in the RO having elements of Table 1 to Table 4 with the access code transmitted from the multimedia player 210. When the transmitted access code is identical to the access code stored in the RO, the DRM agent 220 decrypts data for executing the second stage and then transmits the decrypted data to the multimedia player 210 in step 423. The multimedia player 210 executes a game corresponding to the second stage by using the received data and provides the user with the game. In order to execute a multimedia service content of a next stage, steps 411 to 423 are repeated.

As described above, the present invention effectively manages the consumption right for the stepped multimedia service by including the access condition, which allows an access to the RO for each stage, in the RO corresponding to the content of one stepped multimedia service and making the device obtain information, which satisfies the access condition for every corresponding stage. Also, the user can conveniently obtain the consumption right for each stage and the consumption right can be provided with minimum overhead.

Accordingly, the consumption right for the stepped multimedia service is effectively managed.

Further, the present invention provides a plan for providing proper security, which can support various service models of the operator.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A method for managing a user's consumption right for a multimedia service by a device, the method comprising:
receiving an execution request for a specific multimedia service from a user;
requesting for access information corresponding to an access condition to a service network, when the access condition for the user's consumption right corresponding to the specific multimedia service is set to the consumption right;
receiving the access information from the service network; and
providing the user with a content for the specific multimedia service by a range defined by the consumption right, when the access information meets the access condition.

2. The method as claimed in claim 1, wherein the specific multimedia service includes a plurality of contents provided stage by stage, and the access condition is set such that the access condition corresponds to each of the plurality of contents.

3. The method as claimed in claim 2, wherein requesting access information corresponding to the access condition to the service network comprises:
determining the content requested from the user among the plurality of contents in response to the execution request for the specific multimedia service; and
requesting for specific access information corresponding to a specific access condition to the service network, in response to the requested content, when the specific access condition is set to the consumption right,
wherein providing the user with the content for the specific multimedia service includes identifying whether the specific access information received from the service network meets the specific access condition, and providing the user with the requested content when the specific access information meets the specific access condition.

4. The method as claimed in claim 3, wherein the access condition and the access information are access codes, and the access condition is satisfied when an access code corresponding to the access condition is identical to an access code corresponding to the access information.

5. The method as claimed in claim 4, wherein information related to the consumption right is included in a Right Object (RO) generated by a right issuer and then transferred to the device, the access condition is included in an access element dependent on a permission element for setting a range of the consumption right in the right object, and the access element includes a constraint element representing an expiration date of the access element and a requirement element including contents of the access condition.

6. The method as claimed in claim 5, wherein the requirement element includes an access code corresponding to the access condition.

7. The method as claimed in claim 4, wherein the access code corresponding to the access information is transferred to the device through one of a short message, a multimedia message, and an HTTP (Hypertext Transport Protocol).

8. The method as claimed in claim 5, wherein the access code corresponding to the access information is received from one of the right issuer and a content issuer included in the service network.

9. An apparatus for managing a user's consumption right for a multimedia service in a device, the apparatus comprising:
an agent for requesting for access information corresponding to an access condition to a multimedia player when the access condition for the user's consumption right corresponding to a specific multimedia service is set to the right consumption, and providing the multimedia player with content for the specific multimedia service by a range defined by the consumption right when the access information transferred from the multimedia player meets the access condition, as a result of receiving a request for specific content corresponding to an execution of the specific multimedia service from the multimedia player; and
the multimedia player for transmitting a request for the specific content to the agent, requesting for or transmitting the access information to a service network according to the request for the access information of the agent, transferring the access information to the agent, and executing the content transferred from the agent when receiving an execution request for the specific multimedia service from the user.

10. The apparatus as claimed in claim 9, wherein the specific multimedia service includes a plurality of contents provided stage by stage, and the access condition is set such that the access condition corresponds to each of the plurality of contents.

11. The apparatus as claimed in claim 10, wherein the agent requests for specific access information corresponding to a specific access condition correspondingly set to a content corresponding to the specific content among the plurality of contents to the multimedia player, wherein the multimedia player receives information with regard to a content, to which the access condition is set, among the plurality of contents from the agent, obtains corresponding access information from the service network when there is an execution request for the content, to which the access condition is set, and provides the corresponding access information to the agent.

12. The apparatus as claimed in claim 11, wherein the access condition and the access information are access codes, and the access condition is satisfied when an access code corresponding to the access condition is identical to an access code corresponding to the access information.

13. The apparatus as claimed in claim 12, wherein information related to the consumption right is included in a Right Object (RO) generated by a right issuer to be transferred to the device, the access condition is included in an access element dependent on a permission element for setting a range of the consumption right in the right object, and the access element includes a constraint element representing an expiration date of the access element and a requirement element including contents of the access condition.

14. The apparatus as claimed in claim 13, wherein the requirement element includes an access code corresponding to the access condition.

15. The apparatus as claimed in claim 12, wherein the access code corresponding to the access information is received from one of the right issuer and a content issuer included in the service network.

16. A method for managing a consumption right by a right issuer issuing a user's consumption right for a multimedia service, the method comprising:
receiving a request for issuing the consumption right for a specific multimedia service providing a plurality of contents from a device stage by stage;
generating a Right Object (RO) including information representing a range of the user's consumption right for the specific multimedia service and an access condition for determining whether the consumption right is allowed to access each of the plurality of contents, and then transmitting the generated right object to the device;
receiving, from the device, a request for access information satisfying an access condition corresponding to one content of the plurality of contents; and
transmitting the access information to the device.

17. The method as claimed in claim 16, wherein the access condition and the access information are access codes, and the access condition is satisfied when an access code corresponding to the access condition is identical to an access code corresponding to the access information.

18. The method as claimed in claim 17, wherein the access condition is included in an access element dependent on a permission element for setting a range of the consumption right in the right object, and the access element includes a constraint element representing an expiration date of the access element and a requirement element including contents of the access condition.

19. The method as claimed in claim 18, wherein the requirement element includes an access code corresponding to the access condition.

20. A apparatus for managing a consumption right in a right issuer issuing a user's consumption right for a multimedia service, the apparatus comprising:
a transmission/reception unit for receiving a request for issuing the consumption right for a specific multimedia service providing a plurality of contents from a device stage by stage; and
a manager for generating a Right Object (RO) including information representing a range of the user's consumption right for the specific multimedia service and an access condition for determining whether the consumption right is allowed to access each of the plurality of contents, transmitting the generated right object to the device, receiving from the device a request for access information satisfying an access condition corresponding to one content of the plurality of contents, and transmitting the access information to the device, by using the transmission/reception unit.
